(19) United States
(12) Patent Application Publication
(10) Pub. No.: US 2008/0138029 A1
(43) Pub. Date: Jun. 12, 2008

(54) System and Method For Replay Generation For Broadcast Video

(76) Inventors: Changsheng Xu, Singapore (SG); Kong Wah Wan, Singapore (SG); Lingyu Duan, Singapore (SG); Xinguo Yu, Singapore (SG); Qi Tian, Singapore (SG)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 11/658,204

(22) PCT Filed: Jul. 22, 2005
(86) PCT No.: PCT/SG2005/000248

§ 371 Date: Jun. 18, 2007

Related U.S. Application Data
(60) Provisional application No. 60/590,732, filed on Jul. 23, 2004.

(51) Int. Cl. H04N 5/91

(52) U.S. Cl. 386/46

(57) ABSTRACT

A method and system for generating replays of an event for broadcast video. The method comprises the steps of receiving a video feed, automatically detecting said event from said camera video feed, generating a replay video of said event, and generating broadcast video incorporating said replay. Optionally, the replay video is automatically generated. Optionally, the replay is automatically incorporated into said broadcast video.

### FIELD OF INVENTION

This invention relates broadly to methods and systems for replay generation for broadcast video, and to a data storage medium having stored thereon computer code means for instructing a computer to execute a method for generating replays of an event for broadcast video.

### BACKGROUND OF INVENTION

The growing interest in sporting excellence and patriotic passions at both the international level and the domestic club has created new culture and businesses in the sports domain. Sports video is widely distributed over various networks and its mass appeal to large global audiences has led to increasing research attentions on sports domain in recent years.

Studies have been done on soccer video, and promising results have been reported. These researches mainly focus on semantic annotation, indexing, summarisation and retrieval for sports video. They do not address video editing and production such as automatic replay generation and broadcast video generation.

Generating soccer highlights from a live game is a labour-intensive process. To begin with, multiple cameras are installed all around the sporting arena to maximise coverage. Each camera is often designated a limited aspect of the game such as close-up on coaches and players to capture their emotions. A skilled operator therefore necessarily mans each camera, and their combined entourages add values to the broadcast video to approximate the live atmosphere of the real thing. A broadcast director sits in the broadcast studio, monitoring the multiple video feeds, and deciding which feed to go on-air. Of these cameras, a main camera that is perched high above the pitch level, provides a panoramic view of the game. The camera operator pans-tilts-zooms this camera to track the ball on the field and provide live game footage. This panoramic camera view often serves as the majority of the broadcast view. The broadcast director, however, has at his disposal a variety of state-of-the-art editing video tools to provide enhancement effects to the broadcast. These often come in the form of video overlays that includes textual score-board and game statistics, game-time, player substitutions, slow-motion-replay, etc.

At sporadic moments in the game that he deems appropriate, the director may also decide to launch replays of the prior game action. FIG. 10 shows a diagram of this process. As part of the entire broadcast equipment, logging facilities 1000 are also associated with each individual video feed that can typically store about 60 seconds worth of prior video. When an interesting event, e.g. a goal, has occurred in the game 1006, at the director's command for a replay from the log of a particular camera 1004, the operator presses a button to launch a review of the video feed 1002. The Director then selects an appropriate start segment that will begin playing the video at a slower than real-time rate. The replay from this camera view is typically not more than 15-20 seconds. Therefore the selection of the start segment is crucial and a good selection often comes with experience. The entire replay selection process is typically done within 10 seconds of the event. While the selection is on-going, the video footage would generally switch to the camera views featuring players and coaches close-up, and also possibly crowd cheers and their euphoric reaction. Once the replay selection is completed and the replay is ready to play, the video feed may then switch over to the slow-motion replay video. Furthermore, there are often more than one alternative views of the goal-mouth, e.g. from the front, side, and rear. Therefore, the director may also command that another replay from a second view be launched. All in all, the entire replay sequence would typically last for not more than 30-40 seconds.

These replay clips are then immediately available for further editing and voice-over. Typically, these are then used during the half-time breaks for commentary and analysis. They may also be used to compile a sports summary for breaking news.

At least one embodiment of the present invention seeks to provide a system for automatic replay generation for video according to any of the embodiments described herein.

### SUMMARY OF INVENTION

In accordance with a first aspect of the present invention there is provided a method for generating replays of an event for broadcast video comprising the steps of receiving a video feed; automatically detecting said event from said camera video feed; generating a replay video of said event, and generating broadcast video incorporating said replay.

The replay video may be automatically generated.

The replay may be automatically incorporated into said broadcast video.

Said step of automatically detecting said event may comprise the steps of extracting a plurality of features from said camera video feed, and inputting said features into an event model to detect said event.

Said step of extracting the plurality of features may comprise the step of analysing an audio track of said video feed, determining an audio keyword using said audio analysis and extracting the features using said audio keyword.

Said audio keyword may be determined from a set of whistle, acclaim and noise.

Said step of extracting a plurality of features further may comprise the step of analysing a visual track of said video feed, determining a position keyword using said visual analysis and extracting the features using said position keyword.

Said step of determining a position keyword may further comprise the steps of detecting one or more of a group consisting of field lines, a goal-mouth, and a centre circle using said visual analysis and determining said position keyword using one or more of said group.

Said step of extracting a plurality of features may further comprise the step of determining a ball trajectory keyword using said visual analysis and extracting the features using said ball trajectory keyword.

Said step of extracting a plurality of features may further comprise the step of determining a goal-mouth location keyword using said visual analysis and extracting the features using said goal-mouth location keyword.

Said step of extracting a plurality of features may further comprise the step of analysing the motion of said video feed, determining a motion activity keyword using said motion analysis and extracting the features using said motion activity keyword.

Said step of detecting said event may further comprise the step of constraining the keyword values within a moving window and/or synchronising the frequency of the keyword values for at least one of said position keyword, said ball trajectory keyword, said goal-mouth location keyword, said motion activity keyword and said audio keyword.

Said step of inputting said features into an event model may further comprise the step of classifying said event into one of a group consisting of an Attack event, a Foul event, an “Other” event, and a No event.

The method may further comprise the step of automatically detecting boundaries of said event in the video feed using at least one of the features.

The method may further comprise searching for changes in the at least one of the features for detecting the boundaries.

Said step of generating a replay video of said event may comprise the steps of concatenating views of said event from at least one camera, and generating a slow motion sequence incorporating said concatenated views.

Said step of generating the broadcast video may comprise the step of determining when to insert said replay video according to predetermined criteria.

Said replay video may be inserted instantly or after a delay based on said predetermined criteria.

Said predetermined criteria may depend on classifying said event into one of a group consisting of an Attack event, a Foul event, an “Other” event, and a No event.

Said video feed may be from a main camera.

In accordance with a second aspect of the present invention there is provided a system for generating replays of an event for broadcast video, the system comprising a receiver for receiving a video feed; a detector for automatically detecting said event from said camera video feed; a replay generator for generating a replay video of said event, and a broadcast generator for generating broadcast video incorporating said replay.

Said detector may extract a plurality of features from said camera video feed, and inputs said features into an event model to detect said event.

Said detector may analyse an audio track of said video feed, determines an audio keyword using said audio analysis and extracts the features using said audio keyword.

Said audio keyword may be determined from a set of whistle, acclaim and noise.

Said detector may analyse a visual track of said video feed, determines a position keyword using said visual analysis and extracts the features using said position keyword.

Said detector may further detect one or more of a group consisting of field lines, a goal-mouth, and a centre circle using said visual analysis and determines said position keyword using one or more of said group.

Said detector may determine a ball trajectory keyword using said visual analysis and extracts the features using said ball trajectory keyword.

Said detector may determine a goal-mouth location keyword using said visual analysis and extracts the features using said goal-mouth location keyword.

Said detector may further analyse the motion of said video feed, determines a motion activity keyword using said motion analysis and extracts the features using said motion activity keyword.

Said detector may constrain the keyword values within a moving window and/or synchronises the frequency of the keyword values for at least one of said position keyword, said ball trajectory keyword, said goal-mouth location keyword, said motion activity keyword and said audio keyword.

Said detector may classify said event into one of a group consisting of an Attack event, a Foul event, an “Other” event, and a No event.

Said detector may further detect boundaries of said event in the video feed using at least one of the features.

Said detector may search for changes in the at least one of the features for detecting the boundaries.

Said replay generator may concatenate views of said event from at least one camera, and generate a slow motion sequence incorporating said concatenated views.

Said broadcast generator may determine when to insert said replay video according to predetermined criteria.

Said broadcast generator may insert said replay video instantly or after a delay based on said predetermined criteria.

Said predetermined criteria may depend on classifying said event into one of a group consisting of an Attack event, a Foul event, an “Other” event, and a No event.

Said receiver may receive said video feed from a main camera.

In accordance with a third aspect of the present invention there is provided a data storage medium having stored thereon computer code means for instructing a computer to execute a method for generating replays of an event for broadcast video, the method comprising the steps of receiving a video feed; automatically detecting said event from said camera video feed; generating a replay video of said event, and generating broadcast video incorporating said replay.

### BRIEF DESCRIPTION OF THE DRAWINGS

One preferred form of the present invention will now be described with reference to the accompanying drawings in which;

FIG. 1 is a flow diagram of replay generation and insertion according to one embodiment of the present invention.

FIG. 2 is a flow diagram of how to detect the events from the video taken by the main camera according to one embodiment of the present invention.

FIG. 3 is a flow diagram of how to detect the boundaries of the events according to one embodiment of the present invention.

FIG. 4 illustrates an example of views defined in a soccer game according to one embodiment of the present invention.

FIG. 5 illustrates the example frames of the views defined in a soccer game according to one embodiment of the present invention.

FIG. 6 is a flow diagram of how to generate replays from detected events according to one embodiment of the present invention.

FIG. 7 is a flow diagram of how to insert the replays related to the attack events into the video taken by the main camera according to one embodiment of the present invention.

FIG. 8 is a flow diagram of how to insert the replays related to the foul events into the video taken by the main camera according to one embodiment of the present invention.

FIG. 9 is a flow diagram of the training process to produce parameters of non-intrusive frame detection according to one embodiment of the present invention.

FIG. 10 is a block diagram of typical broadcasting hardware components.

FIG. 11 is a block diagram comparing broadcast and main-camera video according to one embodiment of the present invention.

FIG. 12 is a block diagram of the framework for automatic replay generation system according to one embodiment of the present invention.

FIG. 13 is an illustration of the soccer pitch model according to one embodiment of the present invention.

FIG. 14 is an illustration of Field-line detection according to one embodiment of the present invention.

FIG. 15 is an illustration of goal-mouth detection according to one embodiment of the present invention.

FIG. 16 is an illustration of fast centre circle detection according to one embodiment of the present invention.

FIG. 17 is an illustration of texture filtering according to one embodiment of the present invention.

FIG. 18 is an example graph showing the keywords during an event moment of attack according to one embodiment of the present invention.

FIG. 19 is a graph of an example replay structure according to one embodiment of the present invention.

FIG. 20 is an illustration of the CN output at various locations according to one embodiment of the present invention.

FIG. 21 shows a flow chart illustrating a method for detecting a view change according to an example embodiment.

FIG. 22 shows a flow chart illustrating a method for generating replays of an event for broadcast video according to an example embodiment.

### DETAILED DESCRIPTION OF PREFERRED EMBODIMENTS

With reference to FIG. 11 in order to provide automatic replay generation the present invention may rely on live video from the main camera video feed 1102. Such a live feed contains neither post-production information nor multiple camera views nor commentary information that is available in the broadcast video 1100. Thus fewer cues can be used for event detection in the example embodiment. A further problem is that soccer video (as an example) is “noisy”-low level visual and audio features extracted may be affected by many factors such as audience noise, weather, luminance, etc. Upon detecting the “interesting” segment for replay, a suitable time for replay insertion should be selected to minimise the view interruption from the main camera. For soccer event detection in an example embodiment, the same semantic event can happen in different situation with different duration, as soccer events do not possess strong temporal structure.

FIG. 1 illustrates a method of replay generation and insertion according to one embodiment of the present invention. Replays are generated from the video taken from the main camera 100 and inserted back into the same video to generate broadcast video 110. In detail the events related to replays are detected at step 102 and the boundaries of each respective event detected at step 104 based on the incoming video. The replays may be generated at step 106 based on the detected events and the event boundaries. The generated replay is inserted at step 108 into the live video to generate the broadcast video 110.

Each of the steps in FIG. 1 will be discussed in turn.

### Event Detection

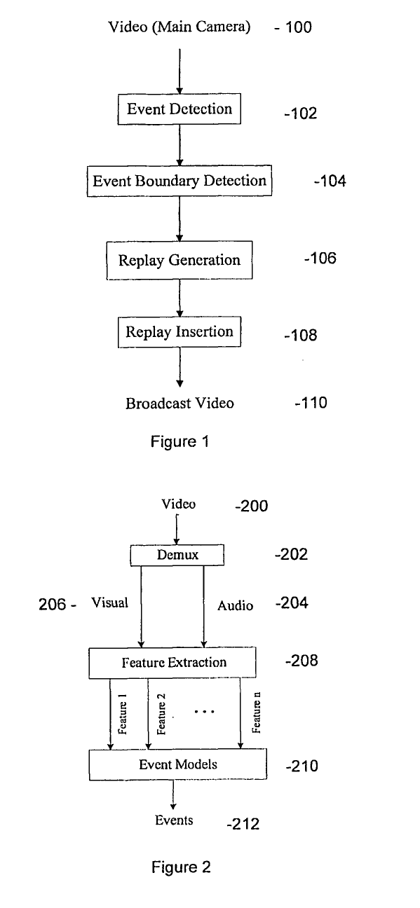

Event detection (referred to in step 102 in FIG. 1) is now described in more detail with respect to FIG. 2. For event detection from the video taken by the main camera, the video 200 is first demuxed at step 202 into visual 206 and audio 204 tracks. From these tracks (and potentially other sources) various features are extracted at step 208. The features are used in various event models at step 210 to detect events within the video.

The feature extraction (step 208 in FIG. 2) is now described in more detail with reference to Table 1. The features extracted result in a set of keywords that will be used in detecting events (step 102 in FIG. 1), generating replays (step 106 in FIG. 1), and replay insertion replays (step 108 in FIG. 1).

TABLE 1
Analysis description table

| ID | Description | Analysis |
|---|---|---|
| F₁ | Active play position | Visual |
| F₂ | Ball trajectory | Visual |
| F₃ | Goal-mouth location | Visual |
| F₄ | Motion activity | Motion |
| F₅ | Audio keyword | Audio |

Visual analysis (F₁, F₂, F₃)

The visual analysis may involve 3 keywords: F₁, F₂, and F₃.

### Position Keyword (F₁)

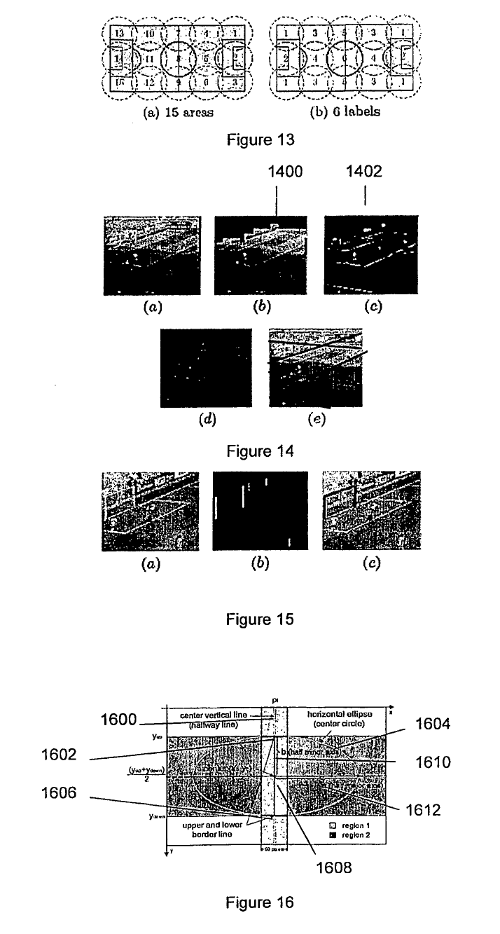

The Position keyword (referred to as F₁ in Table 1) reflects the location of play in the soccer field will now be discussed in more detail with reference to FIGS. 13-15. In the example field shown in FIG. 13a the field is divided into 15 areas or positions. In FIG. 13b symmetrical regions in the field are given the same labels, resulting in 6 keyword labels.

Video from the main camera may be used to identify the play region the field. The raw video will only show a cropped version of the field as the main camera pans and zooms. In one embodiment play regions spanning the entire field are identified. In order to identify the regions, the following three features may be used: (1) field-line locations, (2) goal-mouth location, and (3) centre circle location.

### Field-Line Detection

Field line detection is one factor in determining the F₁ keyword. In detail referring to FIG. 14 in order to detect field lines within a particular frame, each frame is divided into blocks, 16×16 pixels in size as an example. In FIG. 14b dominant colour analysis may then be applied and blocks 1400 with less than half green pixels are blacked out, otherwise the block 1402 remains unchanged. A pixel with (G−R)>T₁ and (G−B)>T₁ is deemed as a green pixel, where R, G, and B are the three colour components of the pixel in RGB colour space, and the threshold T₁ is set to 20 in our system. While this figure was most applicable for most soccer video, one skilled in the art will appreciate it is only an example and an appropriate figure can be easily obtained for any system.

In FIG. 14c the colour image may then be converted to grey scale and edge detection is applied using Laplace-of-Gaussian (LOG) method. To reduce the effect of unbalanced luminance, the LOG edge detection threshold T₂ may be updated adaptively for each block. An initial small threshold may be used which may be allowed to increase until no more than 50 edge pixels (as an example) generated from each block (in our example a line such as field-line will generate 50 edge pixels within a 16×16 block). In FIG. 14d the edges may then be thinned to 1 pixel width and the Hough Transform (HT) may be used to detect lines. The lines detected in each frame may be represented in polar co-ordinates,

(ρᵢ,θᵢ) i=1, 2, . . . , N (1)

where ρᵢ and θᵢ are the i^{th} radial and angular co-ordinate respectively and N is the total number of lines detected in the frame as seen in FIG. 14e.

Goal-Mouth Detection

The detection of two goalposts may be used to identify the goal-mouth which is another factor in determining the F₁ keyword. In more detail referring to FIG. 15 if the goalposts and crossbar are constrained to white in the video feed, a colour based detection algorithm may be adopted. In FIG. 15b the image may be binarized into a black/white image, with white pixels to 1 and other pixels to 0. Vertical line detection and region growing operation may be subsequently applied to detect and fix the broken goalpost candidates, respectively. When performing region growing, every black valued pixel can grow into a white pixel if it is connected with no less than 2 white pixels (using 4-connection).

In FIG. 15a it is apparent that as the main camera is usually at a fixed location overlooking the middle of the field, the goal-mouth view is slanted. We may apply the following domain rules to eliminate non-goalpost pixels:
1. The height of two true goalposts may be nearly the same and within a suitable range.
2. The distance between two true goalposts may be within a suitable range.
3. The two true goalposts may form a parallelogram, as opposed to less likely shapes such as square or trapezium.
4. There may be some white pixels connecting the upper of the two true goalposts due to the presence of the crossbar.
5. In FIG. 15c if there is more than one goalpost candidate left, we may select the two form the biggest goal-mouth as the true goalposts. Testing suggests the accuracy is around 82% over 21540 frames from 5 different game videos. If a goal-mouth is detected, the goal-mouth central point (x_{g},y_{g}) is initialised, otherwise x_{g}=y_{g}=−1

### Centre Circle Detection

Centre circle detection is a further factor in determining the F₁ keyword. Referring now to FIG. 16 due to the position of the main camera, its image capture of the centre circle appears to be an ellipse 1604. To detect this ellipse, the line detection results may be used to locate the halfway line 1600. Secondly, the upper border line 1602 and lower border line 1606 of the possible ellipse may be located by horizontal line detection.

There may be 4 unknown parameters {x₀,y₀,a²,b²} in a horizontal ellipse expression, where (x₀,y₀) is the centre of the ellipse 1608, a and b are the half major axis 1612 and half minor axis 1610 of the ellipse.

The y-axis location of the two horizontal borderlines are yᵤₚ,y_{down}, we have:

$$\begin{matrix}{x}_{0} = {ρ}_{i} & ( 2 ) \\ {y}_{0} = \frac{{y}_{up} + {y}_{down}}{2} & ( 3 ) \\ {b}^{2} = {( \frac{{y}_{down} - {y}_{up}}{2} )}^{2} & ( 4 )\end{matrix}$$

where ρᵢ is the centre vertical line found in Eq. (1). The unknown parameter a² can be computed by the following transform to 1-D parameter space:

$${a}^{2} = \frac{{( x - {x}_{0} )}^{2}}{1 - {( y - {y}_{0} )}^{2} / {b}^{2}} \qquad ( 5 )$$

To improve efficiency, we may only need to evaluate (x,y) from region 2 1604 to compute a².

The above steps may be applied to all possible border line pairs and the a² found with the largest accumulated value in parameter space is considered to be the solution. This method may be able to locate the ellipse even it is cropped provided the centre vertical line, upper and lower border are present. The detected centre circle may be represented by its central point (xₑ,yₑ). If no centre circle is detected, then xₑ=yₑ=−1

Position Keyword Creation

In one embodiment the present invention adopts a Competition Network (CN) to detect the F₁ keyword using the field-lines, the goal-mouth, and the centre circle. The CN consists of 15 dependent classifier nodes, each node representing one area of the field. The 15 nodes compete amongst each other, and the accumulated winning node may be identified as the chosen region of play.

The CN operates in the following manner: at time t, every detected field-line (ρᵢₜ,θᵢₜ), together with the goal-mouth (x_{gt},y_{gt}) and centre circle (xₑₜ,yₑₜ) forms the feature vector vᵢ(t) where i=1 . . . N, N is the number of lines detected at each time t. Specifically, vᵢ(t) is

vᵢ(t)=[ρᵢₜ, θᵢₜ,x_{gt},y_{gt},xₑₜ,yₑₜ]^{T} i=1, . . . , N (6)

The response of each node is

$${r}_{j} ( t ) = {\sum }_{i = 1}^{N} {w}_{j} {v}_{i} ( t ) j = 1 , … , 15 \qquad ( 7 )$$

where

wⱼ=[wⱼ₁, wⱼ₂, . . . , wⱼ₆] j=1, . . . , 15 (8)

is the weight vector associated with the j^{th} node, j=1 . . . 15 for the 15 regions. The set of wining nodes at time t is

$$\{ {j}^{*} ( t ) \} = arg {max}_{j} {\{ {r}_{j} ( t ) \}}_{j = 1}^{j = 15} \qquad ( 9 )$$

However, {j*(t)}sometimes is not a single entry. There are 3 possible scenarios for {j*(t)}, i.e, a single winning entry, a row winning or column winning entry of the regions. This instantaneous winner list may not be the final output of the CN as it may not be robust. To improve classification performance, the accumulated response may be computed as

Rⱼ(t)=Rⱼ(t−1)+rⱼ(t)−α·Dist(j,j*(t))−β (10)

where Rⱼ(t) is the accumulated response of node j, α is a scaling positive constant, β is the attenuation factor, and Dist(j,j*(t)) is the Euclidean distance between node j to the nearest instantaneous wining node within the list{j*(t)}. The variable α−Dist(j,j*(t)) in Eq (10) corresponds to the amount of attenuation introduced to Rⱼ(t) based on the Euclidean distance of node j to the winning node, the further away, the larger the attenuation.

To compute the final output of CN at time t, the maximal accumulated response may be found at node j^{#}(t) where

$${j}^{\#} ( t ) = arg {max}_{j} {\{ {R}_{j} ( t ) \}}_{j = 1}^{j = 15} \qquad ( 11 )$$

If Rⱼ_{_{#}}(t) is bigger than a predefined threshold, the value of position keyword F₁ at time instant t is set to j^{#}(t), otherwise it remains unchanged.

### Ball Trajectory (F₂)

The trajectory of the ball may be useful to recognise some events. For example, the relative position between the ball and goal-mouth can indicate events such as “scoring” and “shooting”. The ball trajectory is obtained using a trajectory-based ball detection and tracking algorithm. Unlike the object-based algorithms, this algorithm does not evaluate whether a sole object is a ball. Instead, it uses a Kalman filter to evaluate whether a candidate trajectory is a ball trajectory. The ball trajectory (F₂ Table 1), may be a two dimensional vector stream recording the 2D co-ordinates of the ball in each frame.

### Goal-Mouth Location (F₃)

Besides being used in position keyword model, goal-mouth location (referred to as F₃ in Table 1) itself may be an important indicator of an event. A goal-mouth can be formed by the two goalposts detected, and may be expressed by its four vertexes: left-top vertex (xᵢₜ, yᵢₜ), left-bottom vertex (x_{ib}, y_{ib}), right-top vertex (xᵣₜ, yᵣₜ), and right-bottom vertex (x_{rb}, y_{rb}). The F₃ keyword is a R⁸ vector stream.

### Motion Analysis (F₄)

In a soccer game, as the main camera generally follows the movement of the ball, the camera motion (referred to as F₄ in Table 1) thus provides an important cue to detect events. In one embodiment the present invention calculates the camera motion keyword using motion vector field information available from the compressed video format.

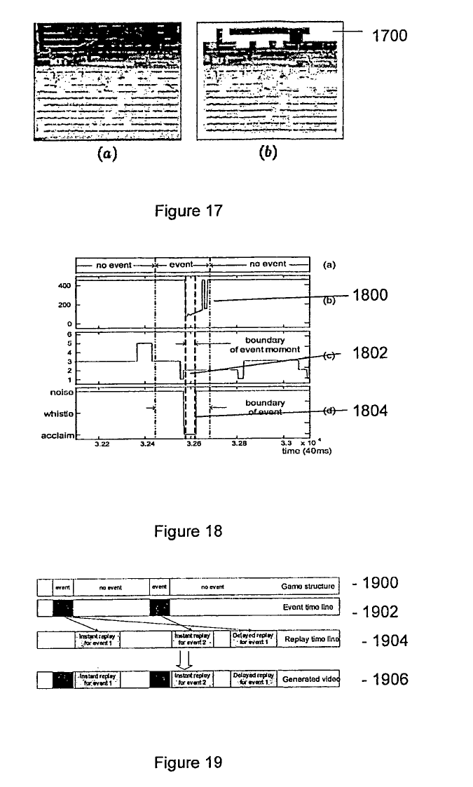

In more detail with reference to FIG. 17 the F₄ keyword generation may involve a texture filter being applied to the extracted motion vectors to improve accuracy. Because MPEG I/II motion vectors are specifically for prediction-correction coding, in low-textured Micro Block (MB), the correlation method for motion estimation might fail to reflect the true motion. It may be better if the motion vectors from low-textured MBs are excluded. We compute the entropy of each MB from 1 frame to measure its texture level, using the following equation:

$$Entropy = - {\sum }_{k = 0}^{255} {p}_{k} * {log}_{2} ( {p}_{k} ) \qquad ( 12 )$$

where Pₖ is the probability of the k^{th} grey-level in the MB. In FIG. 17b if Entropy, is below a threshold T₃, the motion vector 1700 from this MB is excluded. An algorithm is used in the example embodiment to compute the pan factor pₚ, tilt factor pₜ and zoom factor p_{z} of the camera. It is assumed that after the texture filtering, there are totally M high texture MBs included. The coordinate of the i^{th} MB is ξᵢ=(xᵢ, yᵢ)^{T}, its coordinate in the estimated frame is ξ′ᵢ=(x′ᵢ,y′ᵢ)^{T} and the motion vector is μᵢ, we have

$$\begin{matrix}{ξ}_{i} = {ξ}_{i}^{′} + {μ}_{i} \\ and & ( 13 ) \\ \overline{ξ} = \frac{1}{M} {\sum }_{i = 1}^{M} {ξ}_{i} \overline{{ξ}^{′}} = \frac{1}{M} {\sum }_{i = 1}^{M} {ξ}_{i}^{′} \\ So & ( 14 ) \\ {p}_{z} = \frac{{\sum }_{i = 1}^{M} {( {ξ}_{i}^{′} - \overline{{ξ}^{′}} )}^{T} ( {ξ}_{i} - \overline{ξ} )}{{\sum }_{i = 1}^{M} {‖ {ξ}_{i} - \overline{ξ} ‖}^{2}} & ( 15 ) \\ [ \begin{matrix}{p}_{p} \\ {p}_{i}\end{matrix} ] = \frac{{ξ}^{′}}{{p}_{z}} - \overline{ξ} & ( 16 )\end{matrix}$$

Also the average motion magnitude pₘ is computed as:

$${p}_{m} = {‖ \frac{1}{M} {\sum }_{i = 1}^{M} {μ}_{i} ‖}_{2} \qquad ( 17 )$$

Thus a motion activity vector is formed as a measure of the motion activity [p_{z},pₚ,pₜ,pₘ]^{T}.

### Audio Analysis (F₅)

In one embodiment the purpose of the audio keyword (referred to as F₅ in Table 1) may be to label each audio frame with a predefined class. As an example 3 classes can be defined as: “whistle”, “acclaim” and “noise”. In one embodiment the Support Vector Machine (SVM) with the following kernel function is used to classify the audio

$$k ( x , y ) = exp ( \frac{- {\vert x - y \vert}^{2}}{{c}^{2}} ) c = 8 \qquad ( 14 )$$

As the SVM may be a two-class classifier, it may be modified and used as “one-against-all” for our three-class problem. The input audio feature to the SVM may be found by exhaustive search from amongst the following audio features tested: Mel Frequency Cepstral Coefficients (MFCC), Liner Prediction Coefficient (LPC), LPC Cepstral (LPCC), Short Time Energy (STE), Spectral Power (SP), and Zero Crossing Rate (ZCR). In one embodiment a combination of LPCC subset and MFCC subset features are employed.

### Post-Processing

One possible function of post-processing may be to eliminate sudden errors in created keywords. The keywords are coarse semantic representations so the keyword value should not change too fast. Any sudden change in the keyword sequences can be considered as an error, and can be eliminated using majority-voting within a sliding window length of wₗ and step-size wₛ (frame). For different keyword, the sliding window has different wₗ and wₛ defined experientially:
position keyword F₁: wₗ=25 and wₛ=10;
ball trajectory keyword F₂: no post-processing is applied as it has been smoothed by Kalman filter;
goal-mouth location keyword F₃: wₗ=12 and wₛ=8, the sliding window is conducted on −1 and non −1 value;
motion activity keyword F₄: no post-processing is applied as it is objective from compressed video;
audio keyword F₅: wₗ=5 and wₛ=1

Another function of post-processing may be to synchronise keywords from different domains. Audio labels are created based on a smaller sliding window (20 ms in our system) compared with visual frame rate (25 fps, each video frame lasts 40 ms). Since the audio sequence is twice that of video sequence, it is easy to synchronise them.

After post-processing, the keywords are used by the event models (step 210 in FIG. 2) for event detection (step 102 in FIG. 1), in detecting event boundaries (step 104 in FIG. 1), generating replays (step 106 in FIG. 1), and inserting replays (step 108 in FIG. 1)

### Event Models

The event models (referred to as step 210 in FIG. 2) will now be discussed in more detail. This is part of the event detection (step 102 in FIG. 1). The two important areas are:

1. defining general criteria for which event to select for replay.

2. achieving acceptable event detection accuracy from the video taken by the main camera, as fewer cues are available compared with event detection from the broadcast video.

1) Selection of Replay Event

To find general criteria on the selection of event for replay, a quantitative study of 143 replays in several FIFA World-Cup 2002 games was conducted. It may be shown that all of the events replayed belong to three types in Table 2, and our system will generate replay for these events (the types are examples only and a person skilled in the art could generate an appropriate set of event types for a give application).

TABLE 2
Table captions should be placed above the table

| | Total | Attack | Foul | Other |
|---|---|---|---|---|
| Number | 143 | 70 | 67 | 6 |
| Percentage | | 49% | 47% | 4% |

The labelled-event Attack consists of scoring or just-missing shot of a goal. The event Foul consists of a referee decision (referee whistle), and Other consists of injury events and miscellaneous. If none of the above events is detected, the output of the classifier may default to “no-event”.

2) Event Moment Detection

Events may be detected based on the created keywords sequences. In broadcast video the transitions between the type of shot/view may be closely related to the semantic state of the game, so Hidden Markov Model (HMM) classifier, which may be good at discovering temporal pattern, may be applicable. However, when applying HMM on the keyword sequences created in the above section, we noticed that there is less temporal pattern in the keyword sequences, and this makes the HMM method less desirable. Instead we find that there appear certain feature patterns in those keyword sequences at and only at a certain moment during the event. We name such moment with distinguishing feature pattern “event moment”, e.g. the moment of hearing whistle in “Foul”, the moment of very close distance between goal-mouth and ball in “Attack”. By detecting this moment it may be possible to detect the occurrence of the event.

In more detail to classify the three types of events, 3 classifiers are trained to detect event moments for the associated events. To make the classifier robust, each classifier uses a different set of mid-level keywords as input:
Attack classifier: position keyword (F₁), ball trajectory (F₂), goal-mouth location (F₃) and audio keyword (F₅);
Foul classifier: position keyword (F₁), motion activity keyword (F₄) and audio keyword (F₅);
Other classifier: position keyword (F₁) and motion activity keyword (F₄).

The chosen keyword streams are synchronised and integrated into a multi-dimension keyword vector stream from which the event moment is to be detected. To avoid employing the heuristics, a statistical classifier to detect decision boundary is employed, e.g. how small the ball-goal-mouth distance is in “Attack” event, how slow the motions are during a “Foul” event.

The output of each classifier is “Attack”/no-event, “Foul”/no-event and “Other”/no-event respectively. The classifier used is the SVM with the Gaussian kernel (radial basis function (RBF)) in Eq (14).

To train the SVM classifier, event and non-event segments are first manually identified, mid-level representations are then created. To generate the training data, the specific event moments within the events are manually tagged and used as positive examples for training the classifier. Sequences from rest of the clips are used as negative training samples. In the detection process, the entire keyword sequences from the test video are feed to the SVM classifier and the segments with the same statistical pattern as event moment are identified. By applying post-processing, the small fluctuation in SVM classification results is eliminated to avoid reduplicated detection of the event moment from the same event.

In FIG. 18a, the time-line of the game consists of “event”/“no-event” segments. In addition, within the “event” boundary, there may be a smaller boundary of event moment as described above. The event in this example is an “Attack” which may consist of (1) very small “ball-goal-mouth” distance 1800 (FIG. 18b); (2) the position keyword 1802 has value 2 (FIG. 18c) which is designated for the penalty area (FIG. 13b); and (3) the audio keyword 1804 is “Acclaim” (FIG. 18d). The choice of which keywords to select for detecting event moments may be derived from heuristic and/or statistical methods. In the above example, the ball-goal-mouth distance and “position” keyword will be highly relevant to a soccer scoring event. The choice of “audio” keywords relates to the close relationship between a possible scoring event and the response of the spectators.

### Event Boundary Detection

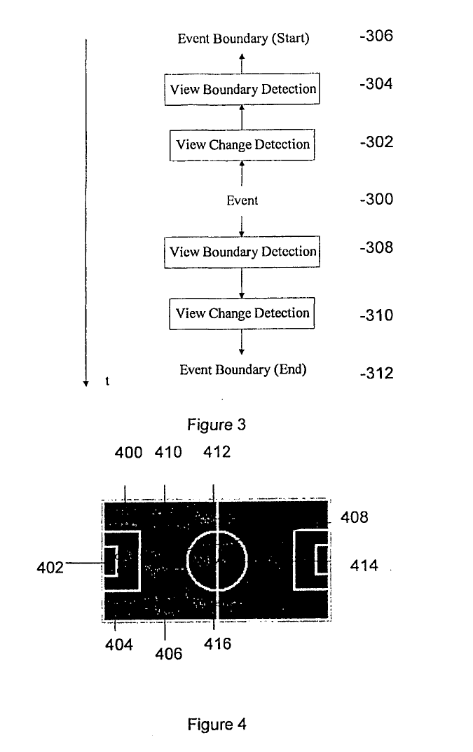

Event boundary detection (referred to as step 104 in FIG. 1) will now be described in more detail with reference to FIGS. 3, 4 and 21. If an event moment is found, a search algorithm will be applied to search backward and forward from the event moment instance to identify the duration of the event. The entire video segment from this duration is used as the replay of the event.

There are many factors affecting the human perception or understanding of the duration of an event: One factor is time, i.e. events usually process only a certain temporal duration. Another factor is the position where the event happens. Mostly events happen in a certain position, hence scenes from previous location may not be of much interest to audience. However, this assumption may not be true for fast changing events.

A first embodiment of event detection is shown in FIG. 3. If an event is detected at step 300, we first analyse the frames taken before this event to detect view change at step 302 and view boundary at step 304 to identify the starting boundary of the event at step 306. Similarly, we also need to analyse the frames taken after the event to identify ending boundary of the event at step 312 by detecting the view change at step 308 and view boundary at step 310. Usually, there is a typical view change pattern for each event in a sports game. After we detect the boundaries of the events, we can have a time period for each event for replay generation.

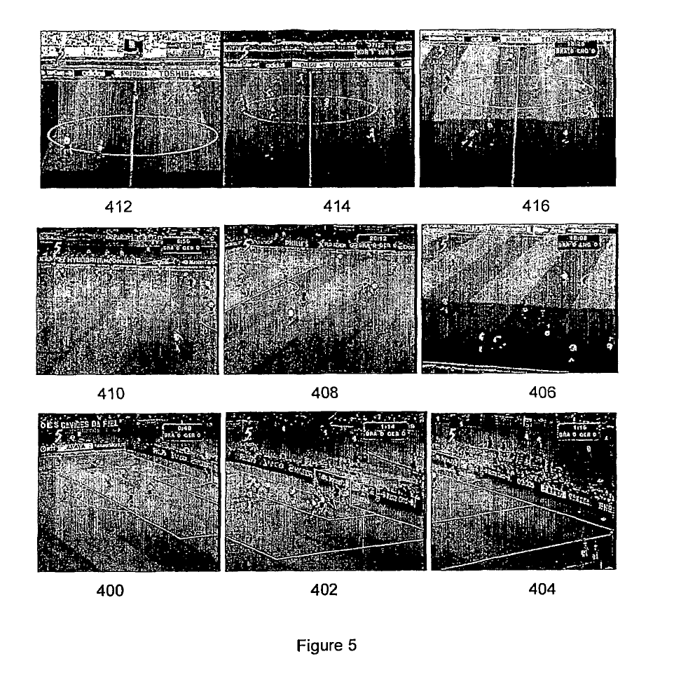

FIGS. 4 and 5 illustrate an example of views defined in a soccer game. In one embodiment 15 views are defined to correspond to different region of a soccer field. For example Upper-Mid 412, Mid-Mid 414, Lower-Mid 416, and for each half Upper-Forward 410, Mid-Forward 408, Lower-Forward 406, Upper-Corner 400, Goal-Box 402 and Lower-Corner 404.

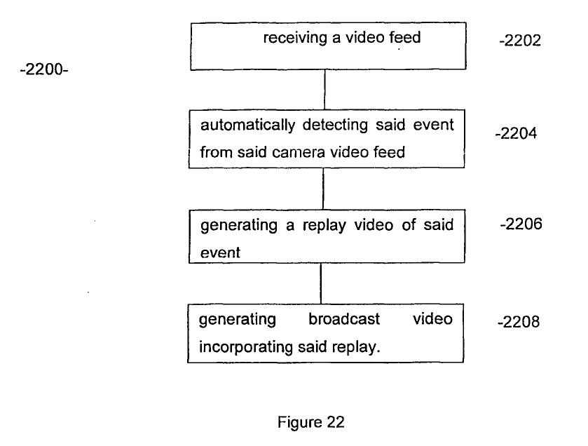

Detecting the view change (referred to as step 302 in FIG. 3) will now be discussed in more detail with reference to FIG. 21. In FIG. 21 the view change is detected using position keyword (F₁) and time duration. Firstly the backward search to identify the starting view change tₛₑ begins by checking if the location keyword F₁ has changed between tₛ−D₁ and tₛ−D₂ (start step 2100, and decisions loop in steps 2102, 2103, 2105), where tₛ is the event moment starting time and D₁,D₂ are the minimal and maximal offset threshold respectively. tₛₒ is set to the time when the location keyword F₁ changes in step 2104, or when the maximum offset threshold D₂ is reached in step 2106.

A forward search is applied to detect the ending view change tₑₑ (referred to as step 308 in FIG. 3). The algorithm (not shown) is similar to the backward search, except the thresholds may be different and that the search moves forward in time. In one embodiment different types of events require different thresholds. Such thresholds can be easily found by empirical evaluations.

### Replay Generation

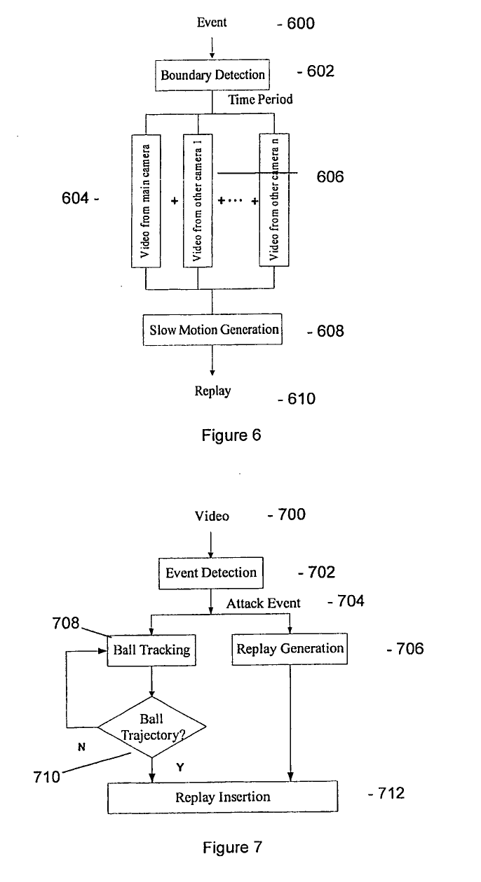

Replay generation (referred to as step 106 in FIG. 1) will now be described in more detail with reference to FIG. 6. After an event 600 and its boundaries may be detected in step 602, we can get a time period corresponding to this event. We may concatenate videos of this period taken by the main camera in step 604 and other cameras in step 606 to form a video sequence. A slow motion of the video sequence is generated in step 608 is then incorporated as the replay of this event in step 610.

### Replay Insertion

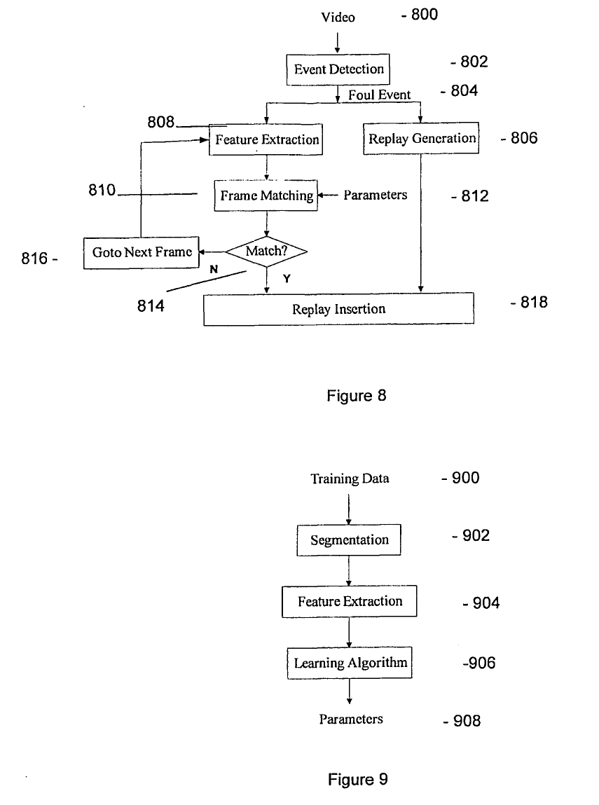

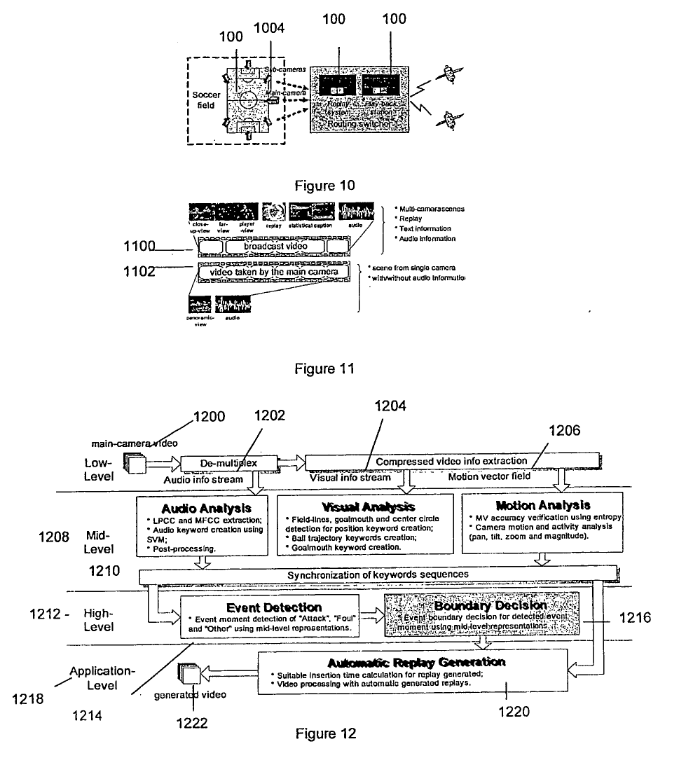

Replay insertion (referred to as step 108 in FIG. 1) will now be described in more detail with reference to FIGS. 7 and 8. Based on the events and event boundaries detected from the video taken by the main camera, we can automatically generate replays for these events and decide whether and where to insert the replays. Since this has been very subjective for human broadcasters, we need to set general criteria for this production. In a first embodiment of replay insertion for an attack event, for example shot on goal in soccer game, the ball trajectory will be existing during the period of event occurring but will be missing after the event ends. Therefore, ball trajectory may be important information to detect the proper position to insert replay.

Referring to FIG. 7 if a detected event in step 702 belongs to attack event 704, the replay of this event is generated in step 706. In parallel, we track the ball in step 708 to determine the ball trajectory. If the ball trajectory is determined to be missing in a frame in step 710, we use this frame as the starting point to insert the replay 712. This is based on the sports game rules.

Since foul events may be different from attack events in sports games, we use a different method to insert replays related to foul events into the video. Referring to FIG. 8 if a detected event in step 802 belongs to foul event 804, the replay of this event is generated in step 806. In parallel, we extract a set of features in step 808 from current video frame received after the event and match them in step 810 to parameters 812 obtained from a learning process. If they match in step 814, the current frame can be used as the starting point to insert replay in step 818. If they do not match, the current frame may not be suitable for replay insertion, and the next frame is examined in step 816.

The parameters and learning process (referred to as step 812 in FIG. 8) will now be discussed in more detail with reference to FIG. 9. The video frames received in step 900 are analysed by the parameter data set, which includes decision parameters and thresholds. For example, the parameter set may specify a certain threshold for the colour statistics of the playing field. This may then be used by the system to segment the video frame into regions of field and non-field in step 902. Then active play zones are determined within the video frame in step 904. Non-active play zones may indicate breaks such as fouls. While the performance will rely on the accuracy of the parameter set that may be trained via an off-line process, using similar video presentations as a learning basis, the system will perform its own calibration with respect to the content-based statistics gathered from the received video frames in step 906.

In a second embodiment of replay insertion Table 3 shows the results of an example quantitative study done on a video database.

TABLE 3
Possible replay insertion place

| | | Delayed replay | | |
|---|---|---|---|---|
| total | Instant Replay | IE | FI | MP |
| 143 | 133 | 3 | 5 | 2 |

MP: missed by panoramic camera;
FI: followed by another interesting segment;
IE: vey important event

It is found from this example that all the replays belong to two classes: instant replay and delayed replay. Most replays are instant replays that are inserted almost immediately following the event if subsequent segments are deemed un-interesting. The other replay class, delayed replay, occurs for several reasons:
a) the event is missed by the panoramic camera (MP),
b) the event to be replayed is followed by an interesting segment (FI), hence the broadcaster has to delay the replay, and
c) the event is important and worth being replayed many times (IE).

The event detection result that has segmented the game into sequentially “event”/“no-event” structure, as illustrated in FIG. 19 row 1 (1900), is the input to the replay generation system. If an event segment is identified, the system examines whether an instant replay can be inserted at the following no-event segment, and react accordingly. This is shown in FIG. 19 row 2 (1902) and 3 (1904) where instant replays are inserted for both event 1 and event 2. In addition, the system will examine whether the same event meets the delayed replay condition. If so, the system buffers the event and inserts the replay in a suitable subsequent time slot. This is shown in FIG. 19 row 2 and 3 where a delayed replay is inserted at a later time slot for event 1. FIG. 19 row 4 (1906) shows the generated video after replay insertion.

### Instant Replay Generation

The replay starting time tᵣₛ and ending time tᵣₑ may be computed as:

tᵣₛ=tₑₑ+D₃ (15)

tᵣₑ=tᵣₛ+(tₑₑ−tₑₛ)*v (16)

where tₑₛ and tₑₑ are the starting and ending time of the event previously. D₃ is set to 1 second in accordance with convention, and v is a factor defining how slow the replay is displayed compared with real-time.

Then the system may examine whether the time slot from tᵣₛ to tᵣₑ in the subsequent no-event segment meets one of the following conditions:
no/low motion;
a high motion but position not at area 2 in FIG. 13b—the penalty area.

If so, an instant replay is inserted.

### Delayed Replay Generation

Delayed replays may be inserted for MP, FI or IE events. The events may be buffered and a suitable time slot found to insert delayed replays. In addition, to identify whether an event is an IE event, an importance measure I is given to the event based on the duration of its event moment as generally the longer the event moment, the more important the event:

I=tₜₑ−tₜₛ (17)

Events with I>T₄ are deemed as important events. In the example embodiment, T₄ is set to 80 frames so that only about 5% of events detected become important events. This ratio is consistent with broadcast video identification of important events. The duration of the delayed replay is the same as the instant replay in the example embodiment. The system will search in subsequent no-event segments for a time slot with tᵣₑ−tᵣₛ in length that meets the condition of no motion.

If such a time slot is found, a delayed replay is inserted. This search continues until a suitable time slot is found for a FI event, or two delayed replays have been inserted for an IE event, or a more important IE event occurs.

In the following results obtained using example embodiments will be described.

Position Keyword

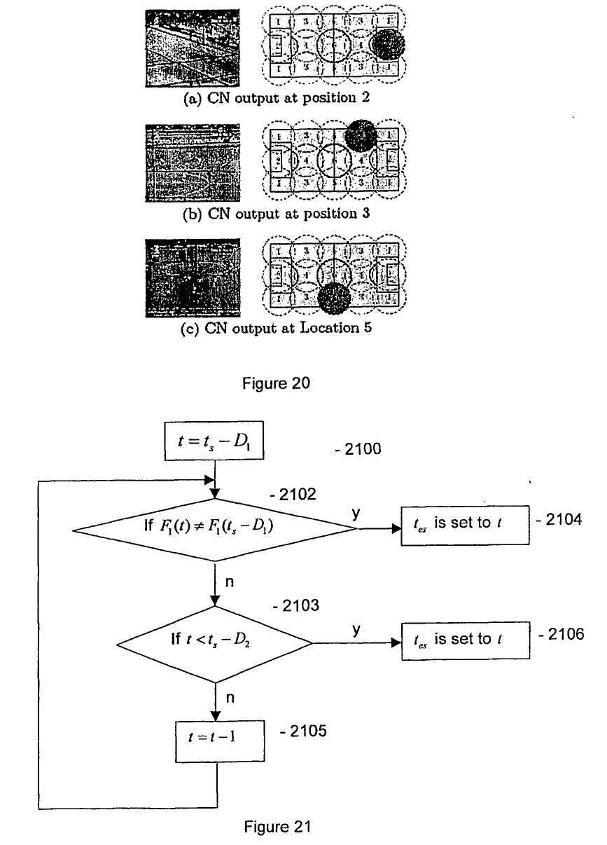

As described in section 3, suitable values of wⱼ in Eq (8) may be chosen such that the CN output is able to update in approximately 0.5 second if a new area is captured by the main camera. FIG. 20 demonstrates the detection of 3 typical areas defined in FIG. 13b, using field-lines, goal-mouth and centre circle detection results.

To evaluate the performance of the position keyword creation, a video database with 7800 frames (10 minutes videos) is manually labelled. The result of keyword generation for this database is compared with the labels and the accuracy of the position keyword is listed in Table 4. It is noted that the detection accuracy for field area 4 is low compared with the other labels. This may be because Field area 4 (FIG. 13b) has fewer cues than the other areas, e.g. it does not have field-lines or goal-mouth or centre circle. This lack of distinct information thus may result in poorer accuracy.

TABLE 4
Accuracy of line model

| Location | Precision | Location | Precision |
|---|---|---|---|
| 1 | 86.3% | 2 | 89.6% |
| 3 | 84.2% | 4 | 49.9% |
| 5 | 77.7% | 6 | 100.0% |

The location is the 6 labels given in FIG. 13(b)

Ball Trajectory

Ball trajectory test is conducted on 15 sequences (176 seconds recording). These sequence consists of various shots with different time duration, view type and ball appearance. Table 5 shows the performance.

TABLE 5
Accuracy of ball trajectory

| #det. & | # false | |
|---|---|---|
| tracked | positive | accuracy |
| 4283 | 25 | 98.8% |

Audio Keyword

Three audio classes are defined: “Acclaim”, “Whistle” and “Noise”. A 30 minutes soccer audio database is used to evaluate the accuracy of the audio keyword generation module. In this experiment, 50%/50% is used as training/testing data set. The performance of the audio feature selected by exhaustive search is compared with existing techniques where feature selection is done by using domain knowledge.

TABLE 6
Accuracy of audio keywords creation

| | Acclaim | Whistle | Noise |
|---|---|---|---|
| existing | 91.2% | 90.8% | 89.2% |
| method | | | |
| example | 93.8% | 94.4% | 96.3% |
| embodiment | | | |

Event Detection

To examine the performance of our system on both main camera video and broadcast video, 50 minutes of unedited video from the main camera recording of S-League game and 4.5 hours of FIFA world cup 2002 broadcast video are used in the experiment. Specifically, as the broadcast video database 1100 is an edited recording, i.e. it has additional shot information besides the main camera capture 1102 (as illustrated in FIG. 11), the non-main-camera shots are identified and filtered out. Only main camera shots are used to simulate the video taken by the main camera. The event detection is performed and the results from these two types of videos are listed in Table 7 and Table 8, respectively.

TABLE 7
Accuracy from unedited video

| | Event | Recall | Precision | BDA |
|---|---|---|---|---|
| Attack | 3 | 60% | 100% | 72.2% |
| Foul | 10 | 77.7% | 70.0% | 71.4% |
| Other | 2 | 50.0% | 50.0% | 80.0% |

TABLE 8
Accuracy from broadcast video

| | Event | Recall | Precision | BDA |
|---|---|---|---|---|
| Attack | 23 | 94.7% | 78.3% | 69.4% |
| Foul | 51 | 83.9% | 72.8% | 80.9% |
| Other | 12 | 80% | 66.7% | 65.0% |

BDA: boundary decision accuracy

The “boundary decision accuracy (BDA)” in Table 7 and Table 8 is computed by

$$BDA = \frac{{τ}_{db} ⋂ {τ}_{mb}}{max ( {τ}_{db} , {τ}_{mb} )} \qquad ( 18 )$$

where τ_{db} and τ_{mb} are the automatically detected event boundary and the manually labelled event boundary, respectively. It is observed that the boundary decision accuracy for event “Other” is lower compared with the other two events. This is because “Other” event is mainly made up of injury or sudden events. The cameraman usually continues moving the camera to capture the ball until the game is stopped, e.g. the ball is kicked out of the touch-line so that the injured player can be treated. Then the camera is focused on the wounded players. This results in either missing the extract event moment by the main camera or an unpredictable duration of camera movement. These reasons affect the event moment detection and hence affect the boundary decision accuracy.

### Automatic Replay Generation

As both the automatically generated video and the broadcast video recorded form broadcast TV program are available in the example embodiment, one can use the later as the ground truth to evaluate the performance of the replay generated. The following table compares the automatic replay generation by an example embodiment to the actual broadcast video replays.

TABLE 9
Replay by broadcast video

| video | Automatic | Broadcast |
|---|---|---|
| total | 37 | 15 |

| | |
|---|---|
| same | 13 |
| missed | 2 |
| recall | 86.7% |
| precision | 35.1% |

The term “same” in Table 9 refers to replays that are inserted in both the automatically generated video and the broadcast video. From Table 9 it can be observed that, though the main camera captures at 3 times slower than real-time speed as the replay (v=3.0 in Eq. 16), the duration of the replay segments generated are shorter that the replays in broadcast video. This may be mainly because the replays in broadcast video use not only the main camera capture but also the sub-camera capture. However, the audience prefer shorter replays as there will be less view interruption in the generated video.

Another result from Table 9 is that the example embodiment generates significantly more replays than human broadcaster's selection. One reason for that result may be that that an automated system will “objectively” generate replays if predefined conditions are met, whereas human generated replays are inherently more subjective. Also, the strict time limit set to generate a replay means that a good replay segment selection might be missed due to the labour intensiveness of manual replay generation. Hence, with the assistance of an automatic system, more replays will be generated. The accuracy of the automated detection algorithms may also vary and may be optimised in different embodiments, e.g. utilising machine learning, supervised learning etc.

The present invention may be implemented in hardware and/or software by a person skilled in the art. In more detail FIG. 12 illustrates the functional modules which comprise one embodiment of the present invention. The low-level modules 1200 extract features from the audio stream 1202, visual stream 1204 and motion vector field 1206. Here we have assumed that the audio information is available from the video taken by the main camera. The mid-level 1208 analyses these features to generate keyword sequences 1210. The high-level 1212 combines these mid-level keywords to detect events 1214 and their boundaries 1216. In addition to these 3 levels, an application level 1218 generates replays 1220 and inserts them into the video 1222 based on event detection results and mid-level representations. It will be appreciated by one skilled in the art that Soccer is only used as an example and the present invention is applicable to a wide range of video broadcasts. For example any application where it is desired to provide replays or highlights of a given video sequence the present invention might be useful.

FIG. 22 shows a flow chart 2200 illustrating a method for generating replays of an event for broadcast video according to an example embodiment. At step 2202, a video feed is received. At step 2204, said event is automatically detected from said camera video feed. At step 2206, a replay video of said event is generated, and at step 2208 broadcast video incorporating said replay is generated.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

1-39. (canceled)

40. A method for generating replays in a broadcast video of a broadcast event, the method comprising the steps of:
receiving a video feed of the broadcast event;
automatically detecting a replay event in the broadcast event from said video feed of the broadcast event;
generating a replay video of said replay event; and
automatically generating the broadcast video of the broadcast event incorporating said replay video.

41. A method as claimed in claim 40 wherein the replay video is automatically generated.

42. A method as claimed in claim 40 wherein said step of automatically detecting said replay event comprises the steps of
extracting a plurality of features from said video feed, and
inputting said features into an event model to detect said replay event.

43. A method as claimed in claim 42 wherein said step of extracting the plurality of features comprises the step of analysing an audio track of said video feed, determining an audio keyword using said audio analysis and extracting the features using said audio keyword.

44. A method as claimed in claim 43 wherein said audio keyword is determined from a set of whistle, acclaim and noise.

45. A method as claimed in claim 42 wherein said step of extracting a plurality of features further comprises the step of analysing a visual track of said video feed, determining a position keyword using said visual analysis and extracting the features using said position keyword.

46. A method as claimed in claim 45 wherein said step of determining a position keyword further comprising the steps of detecting one or more of a group consisting of field lines, a goal-mouth, and a centre circle using said visual analysis and determining said position keyword using one or more of said group.

47. A method as claimed in claim 42 wherein said step of extracting a plurality of features further comprises the step of determining a ball trajectory keyword using said visual analysis and extracting the features using said ball trajectory keyword.

48. A method as claimed in claim 42 wherein said step of extracting a plurality of features further comprising the step of determining a goal-mouth location keyword using said visual analysis and extracting the features using said goal-mouth location keyword.

49. A method as claimed in claim 42 wherein said step of extracting a plurality of features further comprising the step of analysing the motion of said video feed, determining a motion activity keyword using said motion analysis and extracting the features using said motion activity keyword.

50. A method as claimed in claim 43 wherein said step of detecting said replay event further comprises the step of constraining the keyword values within a moving window and/or synchronising the frequency of the keyword values for at least one of said position keyword, said ball trajectory keyword, said goal-mouth location keyword, said motion activity keyword and said audio keyword.

51. A method as claimed in claim 42 wherein said step of inputting said features into an event model further comprises the step of classifying said replay event into one of a group consisting of an Attack event, a Foul event, an “Other” event, and a No event.

52. A method as claimed in claim 42 further comprising the step of automatically detecting boundaries of said replay event in the video feed using at least one of the features.

53. A method as claimed in claim 52 further comprising searching for changes in the at least one of the features for detecting the boundaries.

54. A method as claimed in claim 40 wherein said step of generating a replay video of said replay event comprises the steps of
concatenating views of said replay event from at least one camera, and
generating a slow motion sequence incorporating said concatenated views.

55. A method as claimed in claim 40 wherein said step of generating the broadcast video of the broadcast event comprises the step of determining when to insert said replay video according to predetermined criteria.

56. A method as claimed claim 55 wherein said replay video is inserted instantly or after a delay based on said predetermined criteria.

57. A method as claimed claim 55 wherein said predetermined criteria depend on classifying said replay event into one of a group consisting of an Attack event, a Foul event, an “Other” event, and a No event.

58. A method as claimed in claim 40 wherein said video feed is from a main camera.

59. A system for generating replays in a broadcast video of a broadcast event, the system comprising:
a receiver for receiving a video feed of the broadcast event;
a detector for automatically detecting a replay event in the broadcast event from said video feed of the broadcast event;
a replay generator for generating a replay video of said replay event, and
a broadcast generator for automatically generating the broadcast video of the broadcast event incorporating said replay video.

60. A system as claimed in claim 59 wherein said detector extracts a plurality of features from said video feed, and inputs said features into an event model to detect said replay event.

61. A system as claimed in claim 60 wherein said detector analyses an audio track of said video feed, determines an audio keyword using said audio analysis and extracts the features using said audio keyword.

62. A system as claimed in claim 61 wherein said audio keyword is determined from a set of whistle, acclaim and noise.

63. A system as claimed in claim 62 wherein said detector analyses a visual track of said video feed, determines a position keyword using said visual analysis and extracts the features using said position keyword.

64. A system as claimed in claim 63 wherein said detector further detects one or more of a group consisting of field lines, a goal-mouth, and a centre circle using said visual analysis and determines said position keyword using one or more of said group.

65. A system as claimed in claim 63 wherein said detector determines a ball trajectory keyword using said visual analysis and extracts the features using said ball trajectory keyword.

66. A system as claimed in claim 65 wherein said detector determines a goal-mouth location keyword using said visual analysis and extracts the features using said goal-mouth location keyword.

67. A system as claimed in claim 66 wherein said detector further analyses the motion of said video feed, determines a motion activity keyword using said motion analysis and extracts the features using said motion activity keyword.

68. A system as claimed in claim 67 wherein said detector constrains the keyword values within a moving window and/or synchronises the frequency of the keyword values for at least one of said position keyword, said ball trajectory keyword, said goal-mouth location keyword, said motion activity keyword and said audio keyword.

69. A system as claimed in claim 60 wherein said detector classifies said replay event into one of a group consisting of an Attack event, a Foul event, an “Other” event, and a No event.

70. A system as claimed in claim 60 wherein said detector further detects boundaries of said replay event in the video feed using at least one of the features.

71. A system as claimed in claim 70 wherein said detector searches for changes in the at least one of the features for detecting the boundaries.

72. A system as claimed in claim 59 wherein said replay generator concatenates views of said replay event from at least one camera, and generates a slow motion sequence incorporating said concatenated views.

73. A system as claimed in claim 59 wherein said broadcast generator determines when to insert said replay video according to predetermined criteria.

74. A system as claimed in claim 73 wherein said broadcast generator inserts said replay video instantly or after a delay based on said predetermined criteria.

75. A system as claimed in claim 74 wherein said predetermined criteria depend on classifying said replay event into one of a group consisting of an Attack event, a Foul event, an “Other” event, and a No event.

76. A system as claimed in claim 59 wherein said receiver received said video feed from a main camera.

77. A data storage medium having stored thereon computer code means for instructing a computer to execute a method for generating replays in a broadcast video of a broadcast event, the method comprising the steps of
receiving a video feed of the broadcast event;
automatically detecting a replay event in the broadcast event from said video feed of the broadcast event;
generating a replay video of said replay event; and
automatically generating the broadcast video of the broadcast event incorporating said replay.

78. A system as claimed claim 60 wherein said detector analyses a visual track of said video feed, determines a position keyword using said visual analysis and extracts the features using said position keyword.

79. A system as claimed in claim 78 wherein said detector further detects one or more of a group consisting of field lines, a goal-mouth, and a centre circle using said visual analysis and determines said position keyword using one or more of said group.

80. A system as claimed in claim 60 wherein said detector determines a ball trajectory keyword using said visual analysis and extracts the features using said ball trajectory keyword.

81. A system as claimed in claim 60 wherein said detector determines a goal-mouth location keyword using said visual analysis and extracts the features using said goal-mouth location keyword.

82. A system as claimed in claim 60 wherein said detector further analyses the motion of said video feed, determines a motion activity keyword using said motion analysis and extracts the features using said motion activity keyword.
